(19) United States
(12) Patent Application Publication
(10) Pub. No.: US 2011/0082640 A1
(43) Pub. Date: Apr. 7, 2011

(54) NAVIGATION DEVICE AND METHOD FOR A VEHICLE

(75) Inventors: Aiko BÖHME, Ingelheim (DE); Heiko BALD, Modautal (DE)

(73) Assignee: GM GLOBAL TECHNOLOGY OPERATIONS, INC., Detroit, MI (US)

(21) Appl. No.: 12/895,634

(22) Filed: Sep. 30, 2010

(30) Foreign Application Priority Data
Sep. 30, 2009 (DE) 102009043764.9

(51) Int. Cl. G01C 21/36

(52) U.S. Cl. 701/201

(57) ABSTRACT

A navigation device and a navigation method with a system is provided for obtaining position data about the current position of the vehicle, a data store, which provides navigation data, a route determination system, which uses the position data, the navigation data and destination settings to determine a travel route, an output system for outputting information about the planned travel route and a traffic sign recognition system for detecting traffic signs in the vicinity of the current vehicle position. The route determination system determines an alternative route, if the traffic sign recognition system detects a traffic sign, which prevents travel along the planned route.

### CROSS-REFERENCE TO RELATED APPLICATION

This application claims priority to German Patent Application No. 102009043764.9, filed Sep. 30, 2009, which is incorporated herein by reference in its entirety.

### TECHNICAL FIELD

The invention relates to a navigation device for a vehicle with a system for obtaining position data about the current position of the vehicle, a data store, which provides navigation data, a route determination system, which uses position data, navigation data and destination settings to plan a travel route, an output device for outputting information about the planned route of travel, and a traffic sign recognition system for detecting traffic signs in the vicinity of the current vehicle position. The invention further relates to a navigation method for a vehicle, in which position data concerning the current vehicle position and navigation data are provided and processed, wherein a travel route is planned taking account of destination settings, information concerning the planned route is output and traffic signs in the vicinity of the vehicle are detected and analyzed.

### BACKGROUND

The sensor-based recognition of traffic signs and the processing of the content of the acquired information are described in the prior art in different variants. US patent U.S. Pat. No. 6,801,638 B1 for example is dedicated to the objective of reminding the driver of road-side traffic signs already passed, or classifying them, and further suggests a method for detecting traffic signs and representing them graphically on a display.

In addition, methods and devices for route calculation are known (so-called navigation systems), for supporting the driver in guiding the vehicle to a destination. European patent EP 1 550 097 B1 discloses such a navigation system, which plans routes using road network maps. The effects of possible traffic events on the planned route are simulated in advance and alternative routes for circumventing the junctions along the course of the planned route are calculated and stored. The navigation system according to EP 1 550 097 B1 speeds up the calculation of new route sections as required, provided that messages about actual current traffic problems on the planned route—preferably using a traffic radio receiver device—are obtained.

German patent specification DE 198 42 176 A1 discloses a device and a method of navigation of the kind described at the beginning of the application, in which a recognition system for detecting traffic signs and a system for navigation engage in a bidirectional data exchange. This is intended to increase the safety and reliability of both individual systems (traffic sign recognition system and navigation system). In addition, an analysis is provided in which the traffic sign information obtained is compared with road map information stored in a digital data store of the navigation system and aligned, or updated for the next data access. Detected traffic signs are fed to the navigation system for data enrichment and data management of the digital road map information stored in the data store of the navigation system.

At least one problem addressed by the present invention is to provide a navigation device and a navigation method, which support the vehicle driver in guiding the vehicle to its destination and which facilitate the circumventing of obstacles present on the route hampering or preventing the vehicle from following an originally planned route. In addition, other problems address by the present invention, other desirable features, and characteristics will become apparent from the subsequent summary and detailed description, and the appended claims, taken in conjunction with the accompanying drawings and this background.

### SUMMARY

Accordingly, in a navigation device of the type initially cited, the route determination system determines an alternative route if the traffic sign recognition system has detected a traffic sign which prevents the planned route from being travelled.

In a navigation method of the type described at the beginning, according to an embodiment of the invention it is provided that an alternative route is determined if a traffic sign is detected, which prevents the planned route from being travelled.

A substantial advantage is the instantaneous and safe support for a driver in guiding a vehicle to its destination in the event of an indicated and unexpected obstruction on the route being travelled. On unfamiliar roads in particular, this provides a substantial means of support and avoidance of stress and tension to the driver. This leads to an increase in the driver's confidence in the navigation system. In addition, the navigation device according to an embodiment of the invention can automatically reject or abandon the originally planned route, at least removing it from the driver's focus. This has the further advantage that the output device of the navigation system no longer burdens the driver by warning that it is returning to the originally planned route if the driver, on recognizing an obstacle for example or a diversion sign, deliberately deviates from the planned route.

In one embodiment of the invention the traffic sign recognition system detects a diversion sign and the diversion direction it indicates, and the route determination system determines the alternative route in the direction of the detected diversion direction. The alternative route is in this case determined in the direction of the detected diversion direction and is preferably output immediately by the output device. The driver is thereby supported in route planning and guidance to the destination of the vehicle in the direction of an indicated diversion. On unfamiliar roads in particular, this provides additional security and makes the manual entry of alternative routes into the navigation system or manual searches in road maps unnecessary. The determination of a complete alternative route in the direction of the diversion means that, despite a short-term deviation from the planned direction of travel, the driver is given the feeling of autonomous and secure guidance to their destination around the obstacle.

In a further embodiment of the invention, after detecting the “Diversion” traffic sign, the traffic sign recognition system also determines its diversion direction. In this variant, the route determination system however also checks a second alternative route, which differs from the direction of the detected diversion direction, to see whether this is more favorable than the first alternative route in the diversion direction. If this is affirmed, it can output this second alternative route as the preferred one, or request suggestions. After detecting an obstacle on the travel route therefore, an optimal alternative route—preferably based on time criteria or perhaps driver-specific criteria, such as, e.g., preferred road type—is determined. This depends substantially on the destination and the driver's preferences or other criteria to be observed, and can also therefore run counter to the diversion direction indicated. It is precisely in this case however that the driver is given the confidence to be able to rely on the quality of the navigation.

According to another embodiment of the invention, for one or more junctions that lie ahead in the direction of the alternative route (further ahead), the route determination system can determine and store one or more possible subsequent alternative routes in each case. If the vehicle is located on the displayed alternative route, for example on the indicated diversion route, it is unclear which path the diversion will take at the subsequent junctions. The retention of different alternative routes for the junctions ahead holds alternatives ready for use on demand and leads to increased speed in the calculation and output of a subsequent alternative route. This means the navigation device can automatically determine or detect, whether the necessity for the route diversion has ended and if so, whether to return to the originally planned route.

In a further embodiment of the invention, the traffic sign recognition system detects the diversion signs located further ahead and their directions while the vehicle travels on the determined alternative route, and on the basis of this information the route determination system selects from among the stored subsequent alternative routes the one which leads in the detected direction of the diversion sign. This supports the driver particularly effectively in guiding the vehicle to its destination along the indicated diversion. In particular on unfamiliar roads and/or in conditions of poor visibility it is often difficult for the driver to follow an indicated diversion by visual perception of the diversion signs alone, and it requires a high level of concentration—frequently causing symptoms of tension and stress. The embodiments of the present invention facilitates automated guiding through an indicated diversion with a very high reaction speed, because the possible subsequent alternative routes are calculated, stored and if necessary, immediately available in advance.

If no following diversion sign is detected, the navigation device defines the end of the diversion and does not determine any further alternative routes to be stored for junctions along the remainder of the travel route.

According to a further embodiment of the invention, the output system emits acoustic and/or visual alteration information, if the planned travel route is abandoned and an alternative route is being determined by the route determination system. This information can indicate the path of the changed route and so ensure that the driver is informed in good time and can turn onto the alternative route with due care and caution and follow it.

### BRIEF DESCRIPTION OF THE DRAWINGS

The present invention will hereinafter be described in conjunction with the following drawing figures, wherein like numerals denote like elements, and:

FIG. 1 a schematic plan view of a vehicle with a navigation device according to an embodiment of the invention;

FIG. 2 a schematic view of a first exemplary embodiment of a navigation device according to the invention;

FIG. 3 a schematic view of a second embodiment of a navigation device according to the invention;

FIG. 4 a schematic view of a further embodiment of a navigation device according to the invention; and

FIG. 5 a schematic block circuit diagram of an embodiment of a navigation method according to the invention.

### DETAILED DESCRIPTION

The following detailed description is merely exemplary in nature and is not intended to limit application and uses\. Furthermore, there is no intention to be bound by any theory presented in the preceding background or summary or the following detailed description.

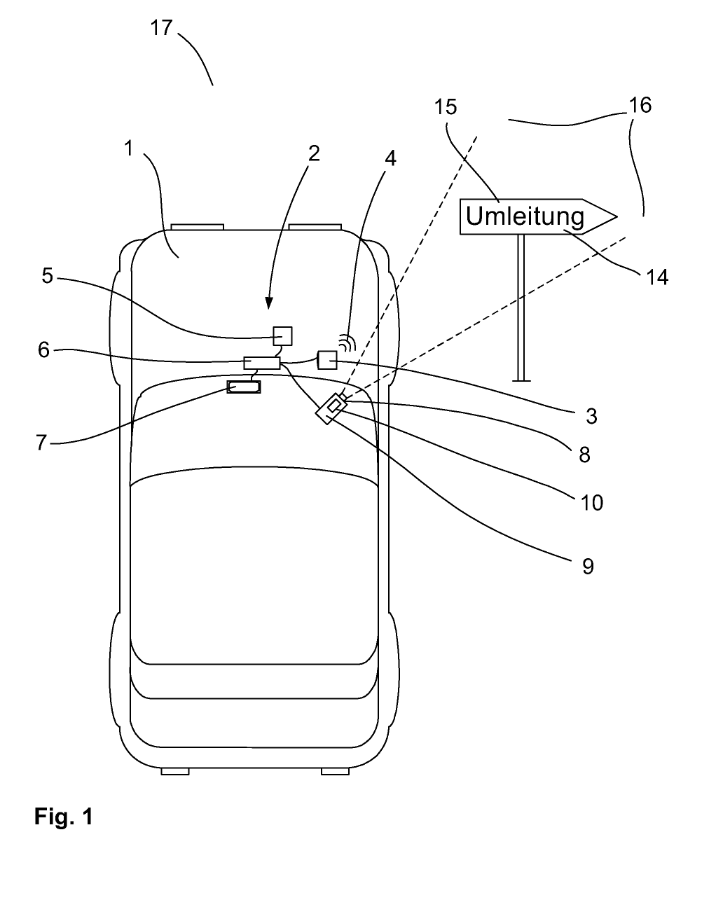

FIG. 1 shows a schematic illustration of a vehicle 1 with a navigation device 2. The navigation device 2 comprises a system 3 for obtaining current position data 4, a data store 5, in which navigation data or map material, for example in the form of digitized road map information, are stored. The navigation data represent, among other things, information about the course, shape and further specifics of the relevant neighborhood or country in which the vehicle is located. The navigation device 2 further comprises a route determination system 6 for calculating a planned route using the navigation data and the position data 4, an output system 7, which is arranged in the visual field of the driver, and a traffic sign recognition system 8. The traffic sign recognition system 8 in this embodiment is constructed from a camera 9 with an optical sensor 10, but it can also be based on other optical methods. The individual components 3, 4, 5, 6, 7 and 8 of the navigation device 2 are connected together by data transmission cables. The traffic sign recognition system 8 detects and recognizes traffic signs 14, such as the diversion sign 15 given in this example. The camera 9 is positioned in the vehicle 1 in such a way that the region 16 detected by sensors includes the region in which traffic signs 14 are positioned on a road 17 relative to the vehicle 1.

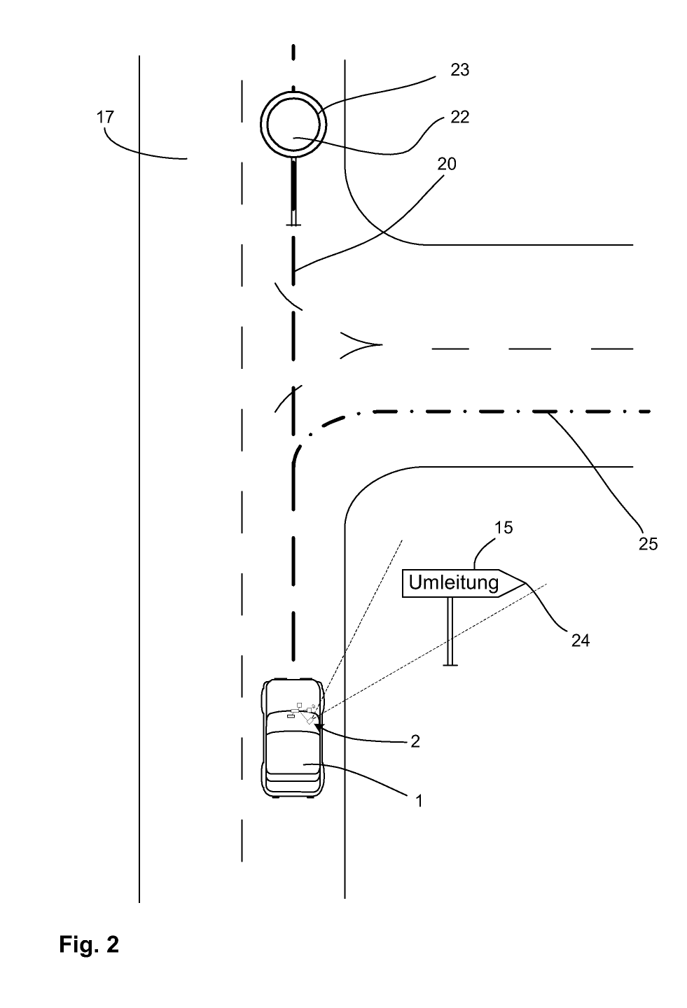

The embodiment of the invention shown in FIG. 2 in a schematic view shows the vehicle 1 from FIG. 1 with the navigation device 2 according to the invention on the road 17. The vehicle is located on a planned route 20, which is displayed to the driver in a known manner in the output system 7 of the navigation device 2.

An obstacle 22, exemplified by a “No through road” traffic sign 23, is located on the planned route 20. Such an obstacle 22 can be, for example, a road works site, a road closure due to an organized event or an emergency, or similar. A diversion sign 15 has been set up and is detected by the traffic sign recognition system 8 in the navigation device 2. The traffic sign recognition system 8 of the navigation device 2 additionally determines the diversion direction 24—i.e. the direction in which the direction arrow of the diversion sign 15 is pointing—whereupon the route determination system 6 determines an alternative route 25 in the diversion direction 24, which is output to the driver in a known manner.

Every type of traffic sign that prevents the planned route 20 from being followed leads to the abandonment of the planned route 20 and the calculation and output of an alternative route 25. Examples of these, in addition to diversion sign 15, are road works signs, No Through Road sign 23 and a No Entry sign.

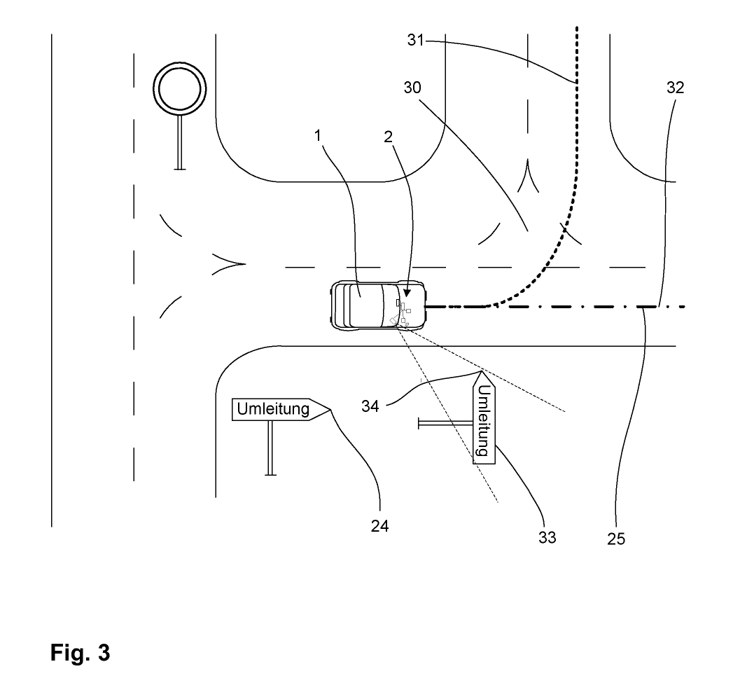

A particularly preferred configuration of the invention is shown schematically in FIG. 3. The vehicle 1 from FIG. 1 and FIG. 2 is located on the alternative route 25 in diversion direction 24. For a junction 30 lying ahead in the path of the alternative route 25, the navigation device 2 generates different subsequent alternative routes 31, 32. These are stored in the navigation device 2. The term “junction” 30 in the context of the present invention is to be understood broadly and also includes road forks, intersections with side roads, T junctions—as shown explicitly in FIG. 3—and comparable road structures. If a further diversion sign 33 is detected along the course of the determined alternative route 25 by the traffic sign recognition system 8, its direction 34 is also determined and the alternative route 31, which leads in the determined diversion direction 34, is output to the driver. Thus the navigation device 2 guides the driver independently through an indicated diversion, reduces his tension and stress and supports him in rapidly guiding the vehicle 1 to its destination.

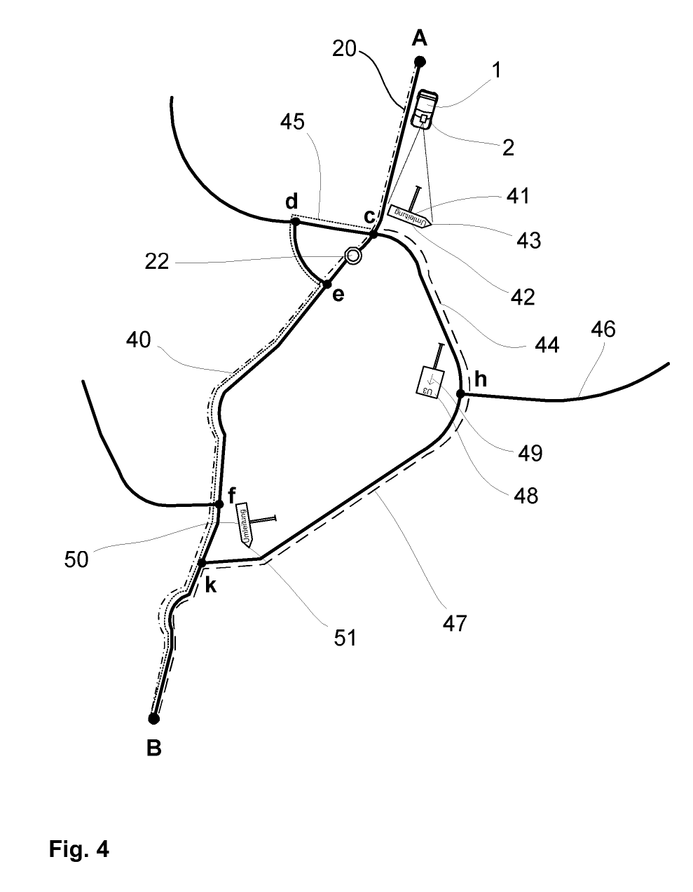

The variant of the device according to the invention shown in schematic view in FIG. 4 shows the vehicle 1 with the navigation device 2 according to the invention. The vehicle 1 is located on a planned route 40 from an original location A to a destination location B (dash-dotted line), which leads via the traffic nodes c, e, f and k to the destination B. If a traffic sign 41, in this case a diversion sign 42, is detected which prevents the planned route 40 from being followed, the planned route 40 is abandoned. On detection of a diversion sign 42 the diversion direction 43 is detected and an alternative route 44, 45, is generated either as: a) alternative route 44 (dashed) in diversion direction 43 or as; b) alternative route 45 (dotted) opposite to diversion direction 43 and is output to the driver in the navigation device 2.

The navigation device 2 determines which alternative route 44, 45 is the more favorable and outputs this accordingly. If the alternative route in diversion direction 43 is found to be more favorable, the path c, h, k to the destination B is output. While the vehicle is travelling along this alternative route 44 the navigation device 2 determines and stores alternative subsequent diversion routes 46, 47 for each junction (in this case the junction h) on the alternative route 44. If a following diversion sign 48 is detected on the alternative route 44, its direction 49 is determined and the stored subsequent alternative route 47, which leads in the detected direction 49, is displayed to the driver in the navigation device 2. Along the course of alternative route 44 the navigation device 2 detects the additional subsequent diversion sign 50 and its direction 51.

If the alternative route opposite to the diversion direction 43, i.e. the path c, d, e, f, k to the destination B, is classified by the navigation device as the more favorable relative to that leading in the diversion direction, this alternative route 45 is output to the driver.

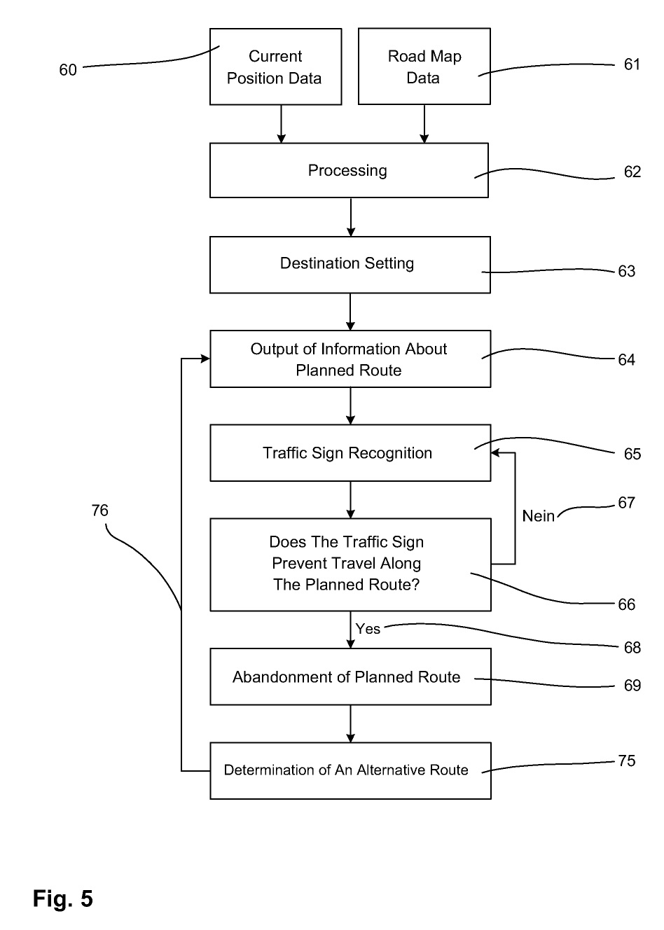

The navigation method according to the invention is shown schematically in FIG. 5 as a flow diagram. Current position data 60 and road map data 61 are processed together (method step 62). A destination setting 63, which exists in the navigation method 1 or is input by a driver, leads to the output of information about the planned route (method step 64), for example a map view of the roads to be travelled.

Traffic signs on the route are detected (method step 65) and a check is performed (method step 66) as to whether a detected traffic sign prevents travel along the planned route. If this is not the case, no action is triggered and the traffic sign recognition is continued. In the block circuit diagram, the “No” branch 67 is followed. If it is determined that the detected traffic sign does prevents travel along the planned route, the “Yes” path 68 in the block circuit diagram is followed and the planned route is abandoned (method step 69). As a result, an alternative route is determined (method step 75) and this is output to the driver (method step 76).

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A navigation device for a vehicle, comprising:
a system adapted to obtain position data about a current position of the vehicle;
a data store adapted to provide navigation data;
a route determination system adapted to use the position data, the navigation data, and a destination setting to plan a travel route;
an output system adapted to output information about the travel route; and
a traffic sign recognition system adapted to detect traffic signs in the vicinity of the current position;
wherein the route determination system is further adapted to determine an alternative route, if the traffic sign recognition system detects a traffic sign that prevents travel along the travel route.

2. The navigation device according to claim 1,
wherein the traffic sign recognition system is adapted to determine a diversion direction on detecting a diversion sign, and
the route determination system is adapted to determine the alternative route along the diversion direction.

3. The navigation device according to claim 1, wherein the traffic sign recognition system is adapted to determine a diversion direction on detecting a diversion sign, and
the route determination system is adapted to determine the alternative route along the diversion direction and a second alternative route that does not follow the diversion direction, and tests for the alternative route that is more favorable.

4. The navigation device according to claim 2, wherein for each of at least one junction that lies ahead in a direction of the alternative route, the route determination system is adapted to determine at least one possible subsequent alternative route and adapted to store the at least one possible subsequent alternative route.

5. The navigation device according to claim 4, wherein while the alternative route is travelled, the traffic sign recognition system is adapted to detect the diversion sign further along a course of the alternative route and the direction of the alternative route, and the route determination system, on a basis of this information, selects from among the subsequent alternative routes the one that leads in a detected direction of the diversion sign.

6. The navigation device according to claim 1, wherein after determining the alternative route, the output system is adapted to emit alteration information.

7. A navigation method for a vehicle, comprising:
processing position data concerning a current position and navigation data
accounting for destination settings in planning a travel route;
generating information about the travel route;
detecting traffic signs in the vicinity of the vehicle;
analyzing the traffic signs in the vicinity of the vehicle; and
determining an alternative route if a traffic sign is detected that prevents travel along the travel route.

8. The method according to claim 7, further comprising:
detecting a diversion sign;
determining a diversion direction when the diversion sign is detected; and
determining the alternative route in the diversion direction.

9. The method according to claim 7, wherein
detecting a diversion sign;
determining a diversion direction when the diversion sign is detected;
determining a first alternative route along the diversion direction and a second alternative route that does not follow a direction of the diversion direction; and
performing a test as to determine which a more favorable alternative route.

10. The method according to claim 7, further comprising:
determining at least one possible subsequent alternative route for at least one junction lying ahead in a direction of the alternative route; and
storing the at least one possible subsequent alternative route.

11. The method according to claim 10, further comprising analyzing diversion signs located further along a course of the alternative route and their direction while the alternative route is travelled; and
selecting the at least one possible subsequent alternative route based upon the one that leads in a detected direction of a diversion sign.

12. The method according to claims 7, further comprising generating information after the alternative route.
